(19) United States
(12) Patent Application Publication
(10) Pub. No.: US 2006/0022459 A1
(43) Pub. Date: Feb. 2, 2006

(54) Hose with corrugated tube

(76) Inventor: Nobuaki Niki, Inuyama-shi (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/192,240

(22) Filed: Jul. 28, 2005

(30) Foreign Application Priority Data
Jul. 30, 2004 (JP) 2004-224616
Jul. 30, 2004 (JP) 2004-224617
Jul. 30, 2004 (JP) 2004-224615

(51) Int. Cl. F16L 27/10

(52) U.S. Cl. 285/223

(57) ABSTRACT

A hose with a corrugated tube has a corrugated tube disposed as an innermost layer. The corrugated tube has a corrugated portion in a shape of corrugations continued in an axial direction. Each of the corrugations includes a corrugation hill on a radially outer side thereof and a corrugation valley on a radially inner side thereof. The corrugation valley includes a bottom portion shaped flat and straight in an axial direction so as to define an axially straight cylindrical inner surface, and an axial length B of an opening portion defined between adjacent said corrugation valleys and an axial length A of the corrugation valley has a relationship of 0.15A=or<B=or<0.5A.

### BACKGROUND OF THE INVENTION

The present invention relates to a hose with a corrugated tube, which is suitable for fuel conveying hose for automobiles, refrigerant conveying hose, hose for conveying battery fuel such as hydrogen gas used in fuel battery or any other hose for conveying any other fluid, in particular such hose having characteristics in measures for restraining flow noise during conveying fluid.

Typical rubber hoses, for example, made of fluorocarbon rubber (FKM), blended product of acrylonitrile-butadiene rubber and polyvinyl chloride (NBR/PVC blend), or the like that are excellent in resistance to fluid permeability, have been used for conveying fuel for automobile (fuel for engine such as gasoline), refrigerant or the like in view of their high vibration-absorbability, easy assembling or the like. However, for the purpose of global environment protection, the regulations have been recently tighten against permeation of fuel for automobiles or the like, and are anticipated to be further tighten in the future. So, such hoses for conveying fuel or refrigerant are demanded to meet the requirements of higher fluid impermeability.

In a hose for conveying a battery fuel such as hydrogen gas used in a fuel battery, required is extremely high impermeability to the fluid to be conveyed such as hydrogen gas.

In order to meet such requirements, it is anticipated difficult to satisfy the future requirements with hoses made only of organic materials such as rubber or resin.

Accordingly, it is currently considered to adapt a hose with a corrugated metal tube having an extremely excellent impermeability to a fluid to be conveyed (having substantially zero permeability) at least as an innermost layer because of this situation.

However, the inventor of the present invention conducted a test of conveying a fluid in such as typical conventional hose with a corrugated tube, and found that flow noise and vibration is generated, specifically when gaseous matter is conveyed at a large volume.

The inventor investigated the cause and found that hill and valley configuration of an inner surface of the corrugated tube easily causes turbulent flow during conveying the fluid, and the turbulent flow itself or resonance of the tube itself induced from the turbulent flow causes flow noise or vibration.

As shown in FIG. 9, a corrugated metal tube 200 has a corrugated portion in a shape of corrugations 206 continued in an axial direction, Each of the corrugations 206 includes a corrugation hill 202 on a radially outer side of the corrugation 206 and a corrugation valley 204 on a radially inner side thereof. Therefore, the corrugated portion has a hill and valley configuration in an inner surface thereof. Due to the hill and valley configuration of the corrugated portion the turbulent flow is generated when a fluid flows inside the corrugated metal tube 200, and the turbulent flow causes flow noise and vibration.

It is stated above that the problems are accompanied with a hose with a corrugated metal tube. However, such problems also occur in hoses with a corrugated tube made of resin or other materials.

In FIG. 9, reference numeral 202a indicates a top portion of the corrugation hill 202 and reference numeral 204a indicates a bottom portion 204 of the corrugation valley 204, respectively.

Such a hose with a corrugated tube is disclosed, for example, in the Patent Documents No. 1 and 2 below. But the disclosures of these patent documents do not refer to generation of turbulent flow, flow noise or vibration that are problems to be solved by the present invention. Also, these disclosures teach no means to solve such problems as in the present invention.

[Patent Document 1] JP, A, 11-159616

[Patent Document 2] JP, A, 2002-195474

Under the circumstances described above, it is an object of the present invention to provide a novel hose with a corrugated tube that can restrain generation of turbulent flow during conveying a fluid, and thereby can restrain generation of flow noise or vibration that is induced by turbulent flow itself or resonance of a tube itself.

### SUMMARY OF THE INVENTION

According to the present invention, there is provided a novel hose with a corrugated tube, which comprises a corrugated tube that is disposed as an innermost layer. The corrugated tube has a corrugated portion in a shape of corrugations continued in an axial direction. Each of the corrugations includes a corrugation hill on a radially outer side thereof and a corrugation valley on a radially inner side thereof. The corrugated portion or the corrugation has an inside space or inside spaces inside the corrugated portion or the corrugation. The inside space or the inside spaces communicate with an inner space within the corrugated tube where fluid flows. The corrugated portion or the corrugation has a restraining structure for restraining generation of turbulent flow in a fluid flow in the inner space or generation of vibrating noise or flow noise due to the fluid flow in the inner space. The word “corrugation” means an entire corrugation hill and an entire corrugation valley continued to the corrugation hill, or a portion extending from a bottom portion (for example, an axial center of the bottom portion) of one corrugation valley to a bottom portion (for example, an axial center of the bottom portion) of a corrugation valley adjacent to the one corrugation valley via a top portion of a corrugation hill between the corrugation valleys.

In the restraining structure according to the one aspect of the present invention, the corrugation includes the corrugation valley that has a bottom portion shaped flat and straight in an axial direction so as to define an axially straight cylindrical inner surface. And, an axial length B of an opening portion that is defined between adjacent corrugation valleys and an axial length A of the corrugation valley (for example, an axial length of an axially longest portion of the corrugation valley or axial length of the bottom portion of the corrugation valley) has a relationship of 0.15A=or<B=or<0.5A.

The corrugation or the corrugated portion may be formed such that the axial length B of the opening portion is smaller than an axial length C of a space inside the corrugation hill of the corrugation (for example, an axial length of an axially longest portion of the space inside the corrugation hill), and thereby the space inside the corrugation hill is wider than the opening portion. Here, a portion, which extends from the bottom portion of one corrugation valley to the bottom portion of the corrugation valley adjacent to the one corrugation valley via a top portion of the corrugation hill between the one and adjacent corrugation valleys, may have a sectional shape (longitudinal sectional shape) like a letter Ω.

And, the corrugation or the corrugated portion may be formed such that an axial distance D between adjacent corrugation hills (for example, an axial distance of an axially shortest portion between adjacent corrugation hills) and an axial length E of the corrugation hill (for example, an axial length of an axially longest portion of the corrugation hill or an outer side of the corrugation hill) has a relationship of 0.16E=or<D.

In the restraining structure in another aspect of the present invention, the corrugation is formed so as to be inclined in an axial direction of the corrugated tube and in an opposite direction of conveying a fluid. The corrugation is inclined, for example, in the opposite direction of conveying a fluid toward a radially outward direction

The corrugation may be formed so as to be inclined at an angle equal to or higher than 30° and lower than 90° with respect to the axial direction.

Here, the corrugation (each of the corrugations) may also include the corrugation valley that has a bottom portion shaped flat and straight in an axial direction so as to define an axially straight cylindrical inner surface.

The corrugation or the corrugated portion may be formed such that a portion, which extends from a bottom portion of one corrugation valley to a bottom portion of the corrugation valley adjacent to the one corrugation valley via a top portion of the corrugation hill between the one and adjacent corrugation valleys, has a sectional shape (longitudinal sectional shape) of a right triangle having a hypotenuse that is inclined inwardly from the top portion or a top of the corrugation hill toward a direction of conveying a fluid

In the restraining structure in yet another aspect of the present invention, a stepped configuration is provided between bottom portions of adjacent corrugation valleys. In the stepped configuration, a starting end of the bottom portion of the corrugation valley on a downstream side of fluid conveyance is located radially outward relative to a terminal end of the bottom portion of the corrugation valley on a upstream side thereof. And, each of the bottom portions may be sloped so as to approach close to an axis of the corrugated tube from the upstream side toward the downstream side.

As stated above, according to the present invention, the corrugated portion or the corrugation has a restraining structure for restraining generation of a turbulent flow in a fluid flow in an inner space within the corrugated tube or restraining generation of a vibrating noise or flow noise due to the fluid flow in the inner space. So, a fluid flows smoothly, generation of turbulent flow and resonance of a tube itself is restrained, and thereby generation of flow noise and vibration can be effectively restrained.

In a first restraining structure according to the present invention, the corrugation includes the corrugation valley that has a bottom portion shaped flat and straight in an axial direction so as to define an axially straight cylindrical inner surface.

In such hose with a corrugated tube according to the one aspect of the present invention, as a fluid can flow smoothly in and along the cylindrical inner surfaces defined by the bottom portions of the corrugations respectively, generation of turbulent flow and resonance of a tube itself is restrained, and thereby generation of flow noise and vibration can be effectively restrained.

Here, the axial length B of the opening portion that is defined between adjacent corrugation valleys and the axial length A of the corrugation valley may have a relationship of B=or<0.5A.

As stated, by reducing the axial length B of the opening portion, discontinued portions that are defined by the opening portions in the cylindrical inner surfaces can be narrowed, thereby smooth flow of a fluid can be facilitated. At the same time, generation of turbulent flow by inflow of fluid through from the openings into an inside space inside the corrugated portion or the corrugation can be more restrained, and resultantly generation of flow noise and vibration can be more effectively prevented accordingly.

However, if the axial length B of the opening portion is designed too small, when the hose with a corrugated tube is curved or bent, adjacent corrugation valleys contact each other, and flexibility of the hose with a corrugated tube is impaired. At the same time, abrasion or the like is caused in the hose with a corrugated tube due to the contact between the adjacent corrugation valleys each other, and resultantly durability of the hose with a corrugated tube is lowered.

Accordingly, the axial length B of the opening portion may be designed a certain length or above, more specifically, equal to or larger than 0.15A (i.e., 0.15A=or<B) to avoid these problems.

And, the axial length B of the opening portion may be designed smaller than the axial length C of the space inside the corrugation hill of the corrugation, and thereby the space inside the corrugation hill may be designed wider than the opening portion. In this configuration, the space inside the corrugation hill can provide wide space to a fluid via the opening portion, each of the corrugations (here, each portion extending from the bottom portion of one corrugation valley to the bottom portion of the corrugation valley adjacent to the one corrugation valley via the top portion of the corrugation hill) can be provided with a function of eliminating noise, thereby it becomes possible to more restrain generation of flow noise and vibration.

Smooth flow of a fluid and noise reduction can effectively achieved by a sectional shape (longitudinal sectional shape) like a letter Ω of the portion that extends from the bottom portion of one corrugation valley to the bottom portion of the corrugation valley adjacent to the one corrugation valley via the top portion of the corrugation hill.

Here, the axial distance D between adjacent corrugation hills and the axial length E of the corrugation hill may have a relationship of 0.16E=or<D, and this can solve a problem that the corrugation hills contact each other when the hose with a corrugated tube is bent or curved.

In a second restraining structure according to the present invention, the corrugation is formed so as to be inclined in the axial direction of the corrugated tube and in the opposite direction of the fluid flow.

In the hose with a corrugated tube according to another aspect of the present invention, it can be effectively prevented that turbulent flow is generated by inflow of fluid from the opening portion between the adjacent corrugation valleys of the corrugated tube inside the corrugated portion or the corrugation.

It is advantageous that the corrugation of the corrugated tube is formed so as to be inclined at an angle equal to or higher than 30° and lower than 90° relative to an axial direction of the corrugated tube. If the corrugation is formed so as to be inclined below 30°, flexibility of the corrugated portion is impaired.

In the second restraining structure, also, the bottom portion of the corrugation valley in the corrugation may be shaped flat and straight in an axial direction and may define an axially straight-walled cylindrical inner surface to secure smooth flow of a fluid in and along the cylindrical inner surface.

And, the corrugation or the corrugated portion may be formed inclined such that a portion, which extends from a bottom portion of one corrugation valley to a bottom portion of the corrugation valley adjacent to the one corrugation valley via a top portion of the corrugation hill between the one and adjacent corrugation valleys, has a sectional shape (longitudinal sectional shape) of a right triangle having a hypotenuse that is inclined inwardly from the top portion or a top of the corrugation hill toward a direction of conveying a fluid.

In a third restraining structure according to the present invention, a stepped configuration is provided between bottom portions of adjacent corrugation valleys, a starting end of a bottom portion of the corrugation valley on a downstream side of fluid conveyance is located radially outward relative to a terminal end of a bottom portion of the corrugation valley on an upstream side thereof, and each of the bottom portions is sloped so as to approach close to an axis of the corrugated tube from the upstream side of the fluid conveyance toward the downstream side thereof. In this construction, the stepped configuration can effectively restrain that a fluid hits against the bottom portion of each corrugation and thereby a turbulent flow is generated during conveying the fluid. Further, as each of the bottom portions is sloped so as to close gradually to an axis of the corrugated tube from the upstream side toward the downstream side, the fluid is allowed to flow smoothly in and along inner surfaces of the bottom portions during conveying the fluid. Thereby generation of fluid noise and vibration resulted from generation of turbulent flow and resonance of a tube itself during conveying a fluid can be effectively restrained.

Now, the preferred embodiments of the present invention will be described in detail with reference to the drawings.

### BRIEF DESCRIPTION OF THE DRAWINGS

FIG. 1 is view (a part shown enlarged) of a first hose with a corrugated tube according to one embodiment of the present invention.

FIG. 2 (A) is an enlarged sectional view of a corrugated metal tube in the one embodiment of the present invention.

FIG. 2 (B) is an enlarged sectional view of a relevant part of the corrugated metal tube in the one embodiment of the present invention.

FIG. 3 is an explanatory view of an action of the corrugated metal tube in the one embodiment of the present invention.

FIG. 4 is a view (a part shown enlarged) of a second hose with a corrugated tube according to another embodiment of the present invention.

FIG. 5 (A) is an enlarged sectional view of a corrugated metal tube in the another embodiment of the present invention

FIG. 5 (B) is an enlarged sectional view of a relevant part of the corrugated metal tube in the another embodiment of the present invention.

FIG. 6 (A) is an enlarged sectional view of a modified corrugated metal tube of the second hose with a corrugated tube.

FIG. 6 (B) is an enlarged sectional view of a relevant part of the modified corrugated metal tube of the second hose with a corrugated tube.

FIG. 7 is a view (a part shown enlarged) of a third hose with a corrugated tube according to yet another embodiment of the present invention

FIG. 8 (A) is an enlarged sectional view of a corrugated metal tube in the yet another embodiment of the present invention

FIG. 8 (B) is an enlarged sectional view of a relevant part of the corrugated metal tube in the yet another embodiment of the present invention.

FIG. 9 is a view of a conventional hose with a corrugated tube.

### DETAILED DESCRIPTIONS OF PREFERRED EMBODIMENTS

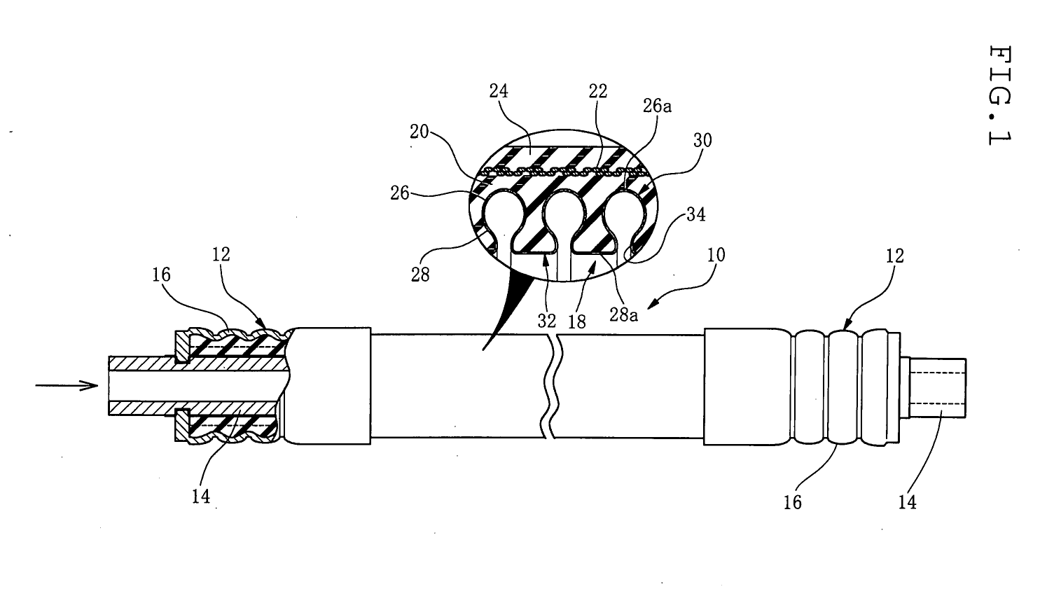

In FIG. 1, reference numeral 10 indicates a first hose with a corrugated tube, and reference numeral 12 indicates a joint fitting which is attached to an end portion of the first hose with a corrugated tube 10. The joint fitting 12 has a pipe-shaped insert fitting 14 and a sleeve-like socket fitting 16. The joint fitting 12, namely the socket fitting 16 and the insert fitting 14 are securely fixed to an end portion of the first hose with a corrugated tube 10 by securely swaging the socket fitting 16 on the first hose with a corrugated tube 10 in a diametrically contracting direction.

The first hose with a corrugated tube 10 has multi-layered construction, a corrugated metal tube 18 as an innermost layer, a middle rubber layer 20 on an outer peripheral side of the corrugated metal tube 18, a reinforcing layer 22 on an outer peripheral side of the middle rubber layer 20 and an outer surface rubber layer 24 on an outer peripheral side of the reinforcing layer 22 as an outermost layer. The middle rubber layer 20 serves also as a filling material.

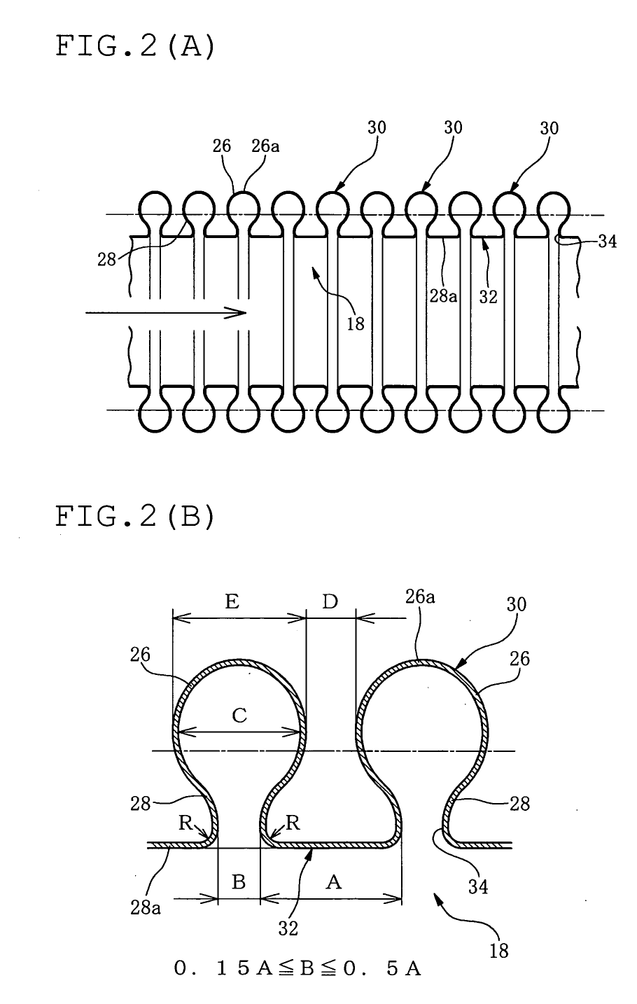

As shown in FIG. 2 (A), the corrugated metal tube 18 has a corrugated portion in shape of corrugations (corrugation units) 30 which are continued in an axial direction. Each of the corrugations 30 includes a corrugation hill 26 on a radially outer side of the corrugation 30 and a corrugation valley 28 on a radially inner side thereof.

In the figure, reference numeral 26a indicates a top portion or a top of the corrugation hill 26, and reference numeral 28a indicates a bottom portion of the corrugation valley 28. Each of the corrugations 30 of the corrugated metal tube 18 defines an inside space inside the corrugation 30, namely a corrugation inside space. The corrugation inside space communicates via an opening portion 34 between adjacent corrugation valleys 28, 28 with an inner space within the corrugated metal tube 18 where fluid flows.

As shown in FIGS. 2(A) and 2 (B), the bottom portion 28a of the corrugation valley 28 according to this first embodiment is shaped flat and straight in an axial direction, and a cylindrical inner surface 32 which is straight-walled in axial direction is defined at and by the bottom portion 28a of each corrugation 30. This structure serves as a first restraining structure.

In FIG. 2 (B), reference numeral 34 indicates an opening portion which is defined between adjacent corrugation valleys 28, 28. In this first embodiment, an axial length B of the opening portion 34 is designed small. Specifically, the axial length B of the opening portion 34 and an axial length A of the corrugation valley 28 (an axial length of an axially longest portion of the corrugation valley 28 or an axial length of the bottom portion 28a of the corrugation valley 28) has a relationship of B=or<0.5A.

And, the axial length B of the opening portion 34 and the axial length A of the corrugation valley 28 also has a relationship of 0.15A=or<B.

The axial length B of the opening portion 34 is designed also smaller than an axial length C of a space inside the corrugation hill 26 or a corrugation hill inside space (an axial length of an axially longest portion of the space inside the corrugation hill 26). The space inside the corrugation hill 26 is wider than the opening portion 34.

In the first embodiment, an axial distance D between the adjacent corrugation hills 26, 26 (an axial distance of an axially shortest portion between the adjacent corrugation hills 26, 26) and an axial length E of the corrugation hill 26 (an axial length of an axially longest portion of the corrugation hill 26) has a relationship of 0.16E=or<D.

That is, the distance (the axial distance D) between the adjacent corrugation hills 26, 26 is designed also a certain distance or above.

The corrugation 30 (here, a portion extending from the bottom portion 28a (more specifically, an axial center thereof) of one corrugation valley 28 to the bottom portion 28a (more specifically, an axial center thereof) of a corrugation valley 28 adjacent to the one corrugation valley 28 via the top portion 26a of the corrugation hill 26) has a sectional shape (longitudinal sectional shape) like a letter Ω. The corrugation 30 includes a pair of foot portions or root portions shaped circular arc with radius R in longitudinal section, respectively

In the first embodiment, the first hose with a corrugated tube 10 has an inner diameter of 14.0 mm. The corrugation 30 has a height (radial height) of 4.0 mm and an outer diameter of 27.0 mm, and the middle rubber layer 20 has a wall thickness (a wall thickness at a radially outermost portion of the corrugation 30) of 1.0 mm.

The opening portion 34 has the axial length B of 1.1 mm and the corrugation valley 28 has the axial length A of 3.6 mm.

And, the axial length C of the space inside the corrugation hill 26 is 3.2 mm, the axial distance D between the adjacent corrugation hills 26, 26 is 1.3 mm, and the axial length E of the corrugation hill 26 is 3.4 mm.

In the first hose with a corrugated tube 10 according to the first embodiment, as a fluid can flow smoothly in and along the cylindrical inner surfaces 32 defined by the bottom portions 28a of the corrugations 30 respectively, generation of turbulent flow and resonance of a tube itself is restrained, thereby generation of flow noise and vibration can be effectively restrained.

And, in the first embodiment, by reducing the axial length B of the opening portion 34, discontinued portions that are defined by the opening portions 34 in the cylindrical inner surfaces 32 can be narrowed, thereby generation of turbulent flow by inflow of fluid through from the opening portions 34 into the inside spaces inside the corrugations 30 can be restrained, and generation of flow noise and vibration can be effectively prevented accordingly.

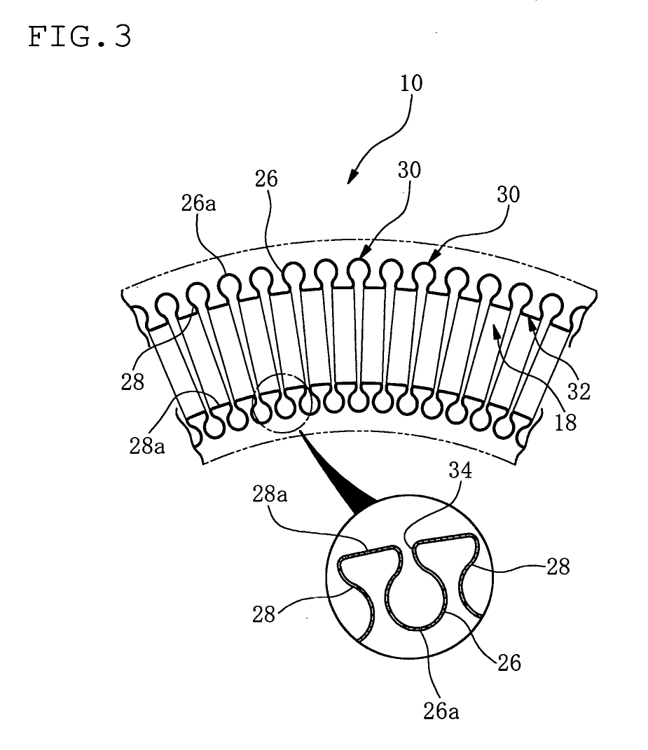

However, if the axial length B of the opening portion 34 is designed too small, when the first hose with a corrugated tube 10 is curved, adjacent corrugation valleys 28, 28 contact each other as shown in FIG. 3, and flexibility of the first hose with a corrugated tube 10 is impaired. At the same time, abrasion or the like is caused in the first hose with a corrugated tube 10 due to contact between the adjacent corrugation valleys 28, 28, and resultantly durability of the first hose with a corrugated tube 10 is lowered.

So, in the first embodiment, the axial length B of the opening portion 34 is designed a certain length or above, specifically, equal to or longer than 0.15A to prevent such problems.

In the first embodiment, the axial length B of the opening portion 34 is designed smaller than the axial length C of the space inside the corrugation hill 26 of the corrugation 30, and the space inside the corrugation hill 26 is designed wider than the opening portion 34. In this configuration, the space inside the corrugation hill 26 provides wide space to a fluid via the opening portion 34, each of the corrugations 30 (here, portions having a longitudinal sectional shape of a letter K) can be provided with a function of eliminating noise, thereby it becomes possible to further restrain generation of flow noise and vibration.

In the first embodiment, the axial distance D between adjacent corrugation hills 26, 26 and the axial length E of the corrugation hill 26 has a relationship of 0.16E=or<D, and this can solve a problem that the corrugation hills 26, 26 contact each other when the first hose with a corrugated tube 10 is bent or curved.

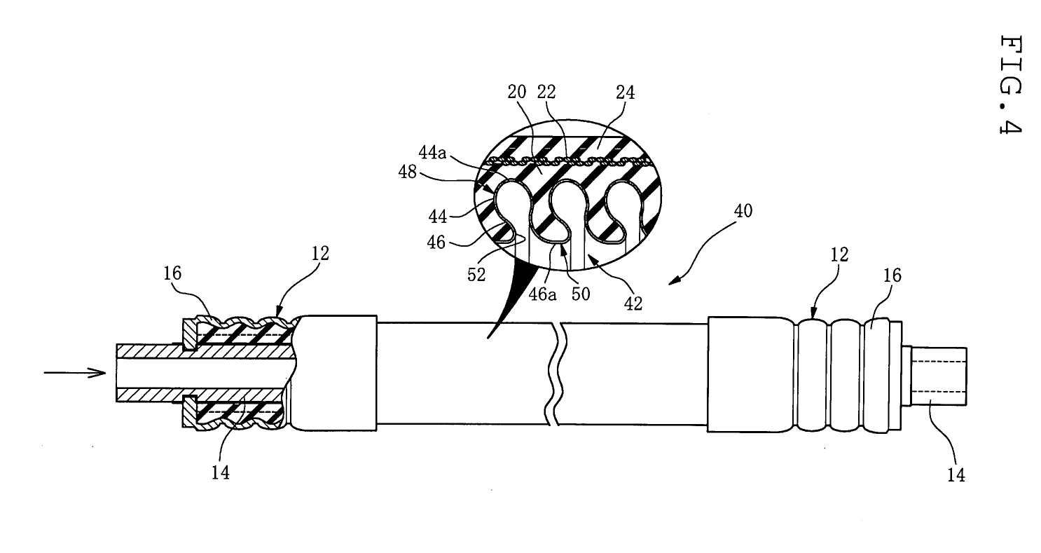

In FIG. 4, reference numeral 40 indicates a second hose with a corrugated tube, and reference numeral 12 indicates a joint fitting which is attached to an end portion of the second hose with a corrugated tube 40. The joint fitting 12 has a pipe-shaped insert fitting 14 and a sleeve-like socket fitting 16. The joint fitting 12, namely the socket fitting 16 and the insert fitting 14 are securely fixed to an end portion of the second hose with a corrugated tube 40 by securely swaging the socket fitting 16 on the second hose with a corrugated tube 40 in a diametrically contracting direction.

The second hose with a corrugated tube 40 has multi-layered construction, a corrugated metal tube 42 as an innermost layer, a middle rubber layer 20 on an outer peripheral side of the corrugated metal tube 42, a reinforcing layer 22 on an outer peripheral side of the middle rubber layer 20 and an outer surface rubber layer 24 on an outer peripheral side of the reinforcing layer 22 as an outermost layer. The middle rubber layer 20 serves also as a filling material.

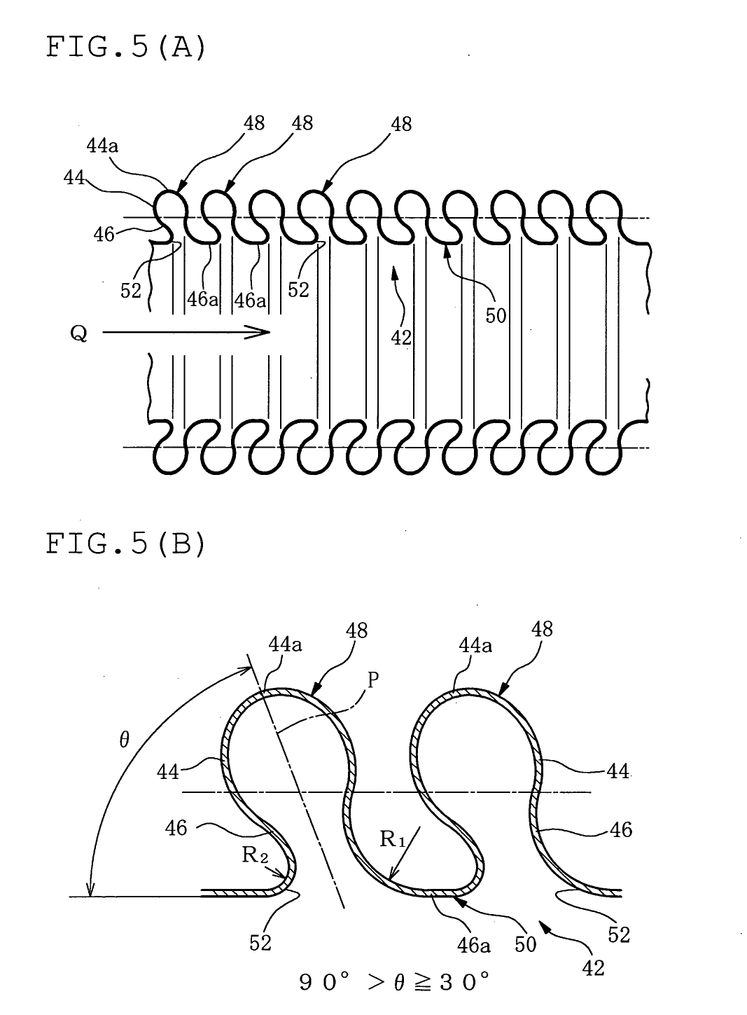

As shown in FIG. 5 (A), the corrugated metal tube 42 has a corrugated portion in a shape of corrugations (corrugation units) 48 which are continued in an axial direction. Each of the corrugations 48 includes a corrugation hill 44 on a radially outer side of the corrugation 48 and corrugation valley 46 on a radially inner side thereof. Each of the corrugations 48 of the corrugated metal tube 42 defines an inside space inside the corrugation 48, namely a corrugation inside space. The corrugation inside space communicates via an opening portion 52 between adjacent corrugation valleys 46, 46 with an inner space within the corrugated metal tube 42 where fluid flows.

In the figure, reference numeral 44a indicates a top portion or a top of the corrugation hill 44, and reference numeral 46a indicates a bottom portion of the corrugation valley 46.

As shown in FIGS. 5 (A) and 5 (B), in the second embodiment, the bottom portion 46a of the corrugation valley 46 is shaped flat and straight in an axial direction, and a cylindrical inner surface 50 which is, for example generally, straight-walled in axial direction is defined at and by the bottom portion 46a of each corrugation 48.

As clearly shown in FIG. 5 (B), in the second embodiment of the present invention, each of the corrugations 48 is formed so as to be inclined in an axial direction of the corrugated tube 42 and an opposite direction of a fluid flow direction indicated by an arrow Q in FIG. 5 (A).

More specifically, as shown in FIG. 5 (B), each of the corrugations 48 is formed such that a line P connecting the top portion or top 44a of the corrugation hill 44 with an axial center of the opening portion 52 between the adjacent corrugation valleys 46, 46 is inclined at an inclining angle θ. This structure serves as a second restraining structure.

Here, the inclining angle θ is an angle equal to or higher than 30° and lower than 90° relative to an axial direction of the corrugated tube 42.

As shown in FIG. 5 (B), the corrugation 48 (here, a portion extending from the bottom portion 46a (more specifically, an axial center thereof) of one corrugation valley 46 to the bottom portion 46a (more specifically, an axial center thereof) of a corrugation valley 46 adjacent to the one corrugation valley 46 via a top portion 44a of the corrugation hill 44) includes a pair of foot portions or root portions shaped circular arc with radius R₁, R₂ in longitudinal section, respectively.

In the second embodiment, the second hose with a corrugated tube 40 has an inner diameter of 14.0 mm. The corrugation 48 has a height (radial height) of 4.0 mm and an outer diameter of 27.0 mm, and the middle rubber layer 20 has a wall thickness (a wall thickness at a radially outermost portion of the corrugation 48) of 1.0 mm. The inclining angle θ of the corrugation 48 is designed 70° here (namely, the line P is inclined at 20° relative to a radial direction).

As stated above, in the second embodiment, as the corrugation 48 of the corrugated tube 42 is formed so as to be inclined in the axial direction of the corrugated tube 42 and in the opposite direction of the fluid flow, it can be effectively prevented that turbulent flow is generated by inflow of fluid from the opening portion 52 between the adjacent corrugation valleys 46, 46 inside the corrugation 48.

And, in the second embodiment, the bottom portion 46a of the corrugation valley 46 in the corrugation 48 is shaped flat and straight in an axial direction, and defines an axially straight-walled cylindrical inner surface 50. The straight-walled cylindrical inner surface 50 allows to flow a fluid smoothly in and along the cylindrical inner surface 50. Thereby generation of turbulent flow and resonance of a tube itself can be restrained, and thereby generation of fluid noise and vibration can be more favorably restrained.

In the above second embodiment, the corrugation 48 (here, a portion extending from the bottom portion 46a (more specifically, an axial center thereof) of one corrugation valley 46 to the bottom portion 46a (more specifically, an axial center thereof) of a corrugation valley 46 adjacent to the one corrugation valley 46 via a top portion 44a of the corrugation hill 44) has a sectional shape (longitudinal sectional shape) like a letter Ω where an axial length of the space inside the corrugation hill 44 (an axial length of an axially longest portion of the space inside corrugation hill 44) is larger than the axial length of the opening potion 52, and the space inside the corrugation hill 44 is wider than the opening portion 52. However, the present invention can be adapted to corrugated tubes 42 having corrugations 48 of various forms and shapes.

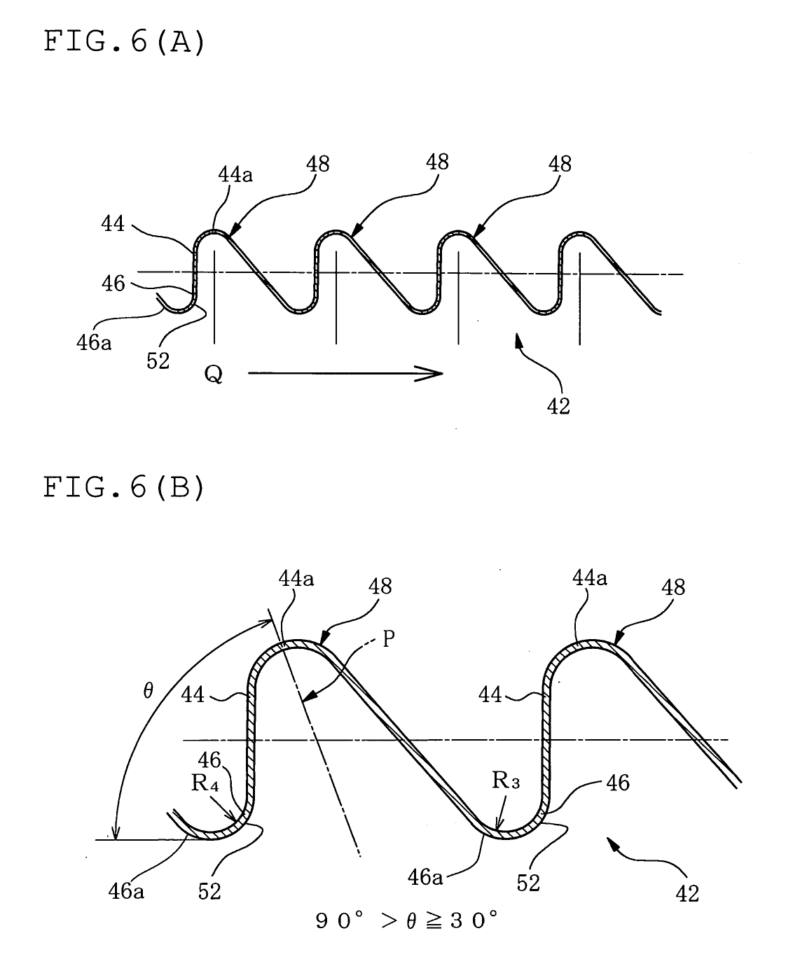

FIG. 6 shows another aspect of this second embodiment and second restraining structure.

In the another aspect of the second embodiment, the corrugation 48 is designed such that an axial length of the opening portion 52 is large relative to a space inside the corrugation hill 44, a bottom portion 46a of the corrugation valley 46 is not flat and straight in an axial direction but protrudes radially inwardly. The present invention may be adapted to the second hose with a corrugated tube 40 that has such configuration.

In this configuration shown in FIG. 6, the corrugation 48 is also formed such that a line P connecting the top portion or a top 44a of the corrugation hill 44 with an axial center of the opening portion 52 between the adjacent corrugation valleys 46, 46 is inclined at an inclining angle θ. Therefore, each of the corrugations 48 is formed so as to be inclined in an axial direction of the corrugated tube 42 and an opposite direction of a fluid flow direction indicated by an arrow Q in FIG. 6 (A) at an angle θ. Here, a portion, which extends from the bottom portion 46a (for example, an axial center thereof) of one corrugation valley 46 to the bottom portion 46a (for example, an axial center thereof) of the corrugation valley 46 adjacent to the one corrugation valley 46 via the top portion 44a of the corrugation hill 44 between the one and adjacent corrugation valleys 46, has a sectional shape (longitudinal sectional shape) of a right triangle (like a right triangle) having a hypotenuse that is inclined inwardly from the top portion or the top 44a of the corrugation hill 44 toward a direction of conveying a fluid. The corrugation 48 (here, a portion extending from the bottom portion 46a (for example, an axial center thereof) of one corrugation valley 46 to the bottom portion 46a (for example, an axial center thereof) of a corrugation valley 46 adjacent to the one corrugation valley 46 via the top portion 44a of the corrugation hill 44) includes a pair of foot portions or root portions shaped circular arc with radius R₃, R₄ in longitudinal section, respectively.

In the corrugated tube 42 having the corrugation 48 of such shape, specifically in the second hose with a corrugated tube 40 including such corrugated tube 42 as an innermost layer, an inclined shape of each corrugation 48 can also favorably restrain flow noise and vibration during conveying a fluid.

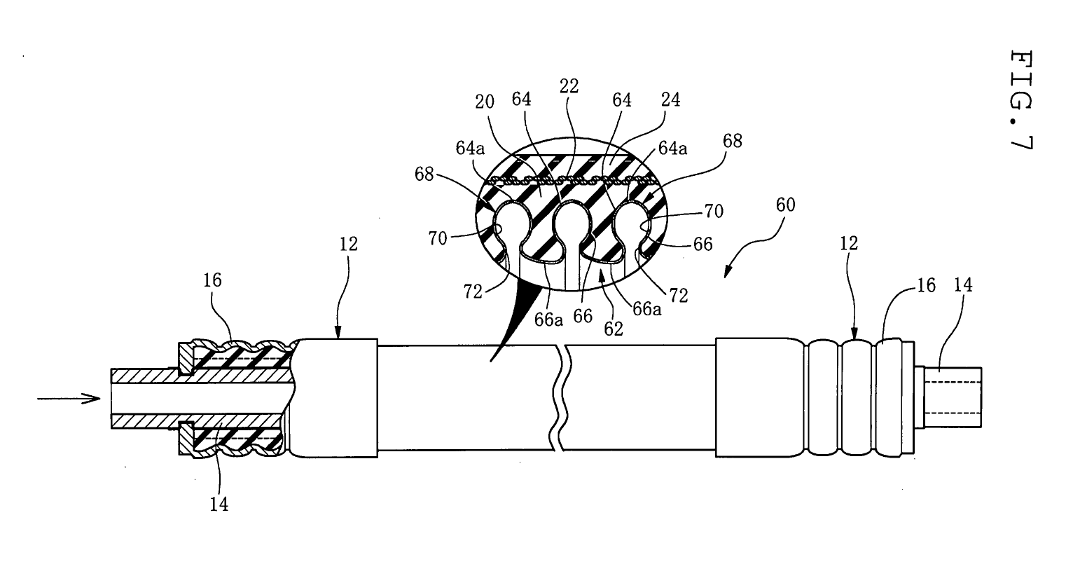

In FIG. 7, reference numeral 60 indicates a third hose with a corrugated tube, and reference numeral 12 indicates a joint fitting which is attached to an end portion of the third hose with a corrugated tube 60. The joint fitting 12 has a pipe-shaped insert fitting 14 and a sleeve-like socket fitting 16. The joint fitting 12, namely the socket fitting 16 and the insert fitting 14 are securely fixed to an end portion of the third hose with a corrugated tube 60 by securely swaging the socket fitting 16 on the third hose with a corrugated tube 60 in a diametrically contracting direction.

The third hose with a corrugated tube 60 has multi-layered construction, a corrugated metal tube 62 as an innermost layer, a middle rubber layer 20 on an outer peripheral side of the corrugated metal tube 62, a reinforcing layer 22 on an outer peripheral side of the middle rubber layer 20 and an outer surface rubber layer 24 on an outer peripheral side of the reinforcing layer 22 as an outermost layer. The middle rubber layer 20 serves also as a filling material.

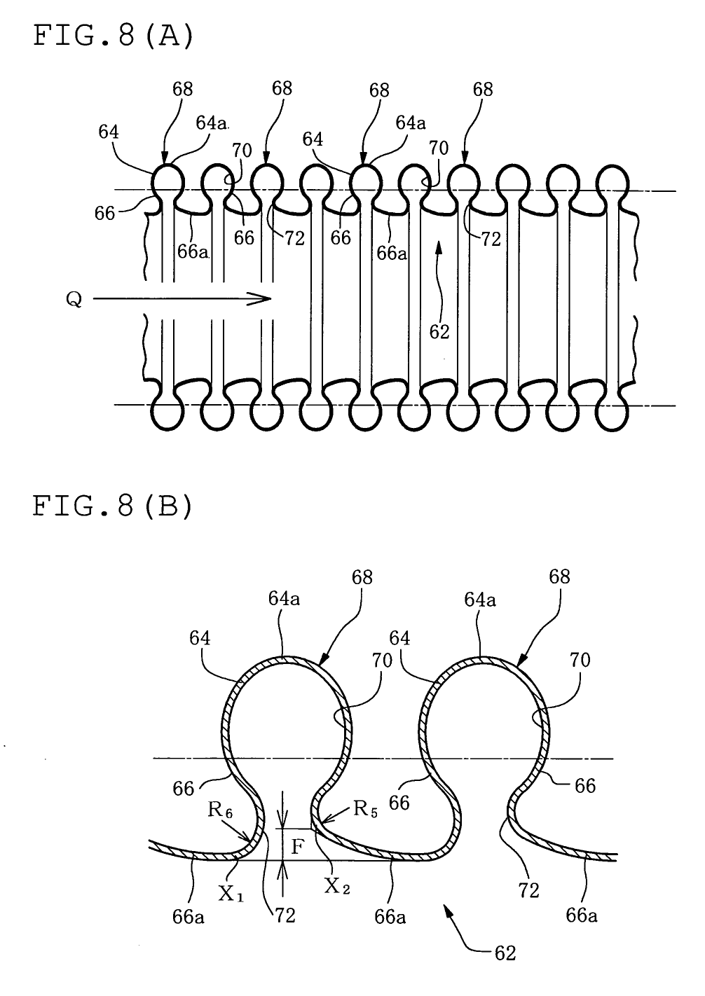

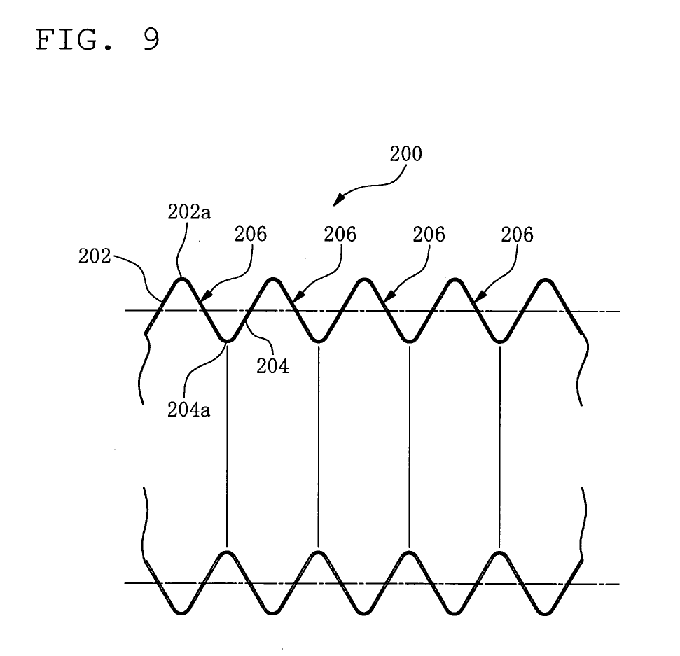

As shown in FIG. 8 (A), the corrugated metal tube 62 has a corrugated portion in shape of corrugations (corrugation units) 68 which are continued in an axial direction. Each of the corrugations 68 includes a corrugation hill 64 on a radially outer side of the corrugation 68 and a corrugation valley 66 on a radially inner side thereof.

In the figure, reference numeral 64a indicates a top portion of the corrugation hill 64, and reference numeral 66a indicates a bottom portion of the corrugation valley 66.

As shown in FIG. 8, each of the corrugations 68 of the corrugated metal tube 62 defines an inside space 70 inside the corrugation 68, namely a corrugation inside space 70. The corrugation inside space 70 communicates via the opening portion 72 between adjacent corrugation valleys 66, 66 with an inner space within the corrugated metal tube 62 where fluid flows.

In this third embodiment of the present invention, as shown in FIG. 8 (B), a stepped configuration (refer to reference letter F) is provided between the bottom portions 66a, 66a of the adjacent corrugation valleys 66. In the stepped configuration, a starting end X₂ of the bottom portion 66a of the corrugation valley 66 on a downstream side of fluid conveyance is located radially outward relative to a terminal end X₁ of the bottom portion 66a of the corrugation valley 66 on an upstream side thereof at a step height F (a fluid to be conveyed flows in a direction indicated by an arrow Q in FIG. 8 (A)). This structure serves as a third restraining structure.

And, each of the bottom portions 66a takes a gently curved and sloped shape so as to approach close to an axis or a side of the axis of the corrugated metal tube 62 from the starting end X₂ toward the terminal end X₁, namely from the upstream side toward the downstream side.

Here, the bottom portion 66a may take an inclined shape, for example, inclined straight shape instead of such curved and sloped shape.

As shown in FIG. 8 (B), the corrugation 68 (here, a portion extending from the bottom portion 66a (more specifically, an axial center thereof) of one corrugation valley 66 to the bottom portion 66a (more specifically, an axial center thereof) of a corrugation valley 66 adjacent to the one corrugation valley 66 via the top portion 64a of the corrugation hill 64) includes a pair of foot portions or root portions shaped circular arc with radius R₅, R₆ in longitudinal section, respectively.

In the third embodiment, the third hose with a corrugated tube 60 has an inner diameter of 14.0 mm. The corrugation 68 has a height (radial height) of 4.0 mm and an outer diameter of 27.0 mm, and the middle rubber layer 20 has a wall thickness (a wall thickness at a radially outermost portion of the corrugation 68) of 1.0 mm. A step height (radial height) F of 0.7 mm is defined in the stepped configuration.

As stated, in this embodiment, as there is provided the stepped configuration where the starting end X₂ of the bottom portion 66a on the downstream side of fluid conveyance is located radially outward relative to the terminal end X₁ of the bottom portion 66a on the upstream side thereof at the step height F, it can be effectively restrained that a fluid hits against the bottom portion 66a of each corrugation 68 during conveying a fluid and thereby a turbulent flow is generated.

Further, as the bottom portion 66a takes a curved shape or inclined shape so as to approach gradually close to the axis or the side of the axis of the corrugated metal tube 62 from the upstream side toward the downstream side, the fluid is allowed to flow smoothly in and along inner surfaces of the corrugation bottoms 66a.

Thereby generation of fluid noise and vibration resulted from generation of turbulent flow and resonance of a tube itself during conveying a fluid can be effectively restrained.

Although the preferred embodiments have been described above, this is only some of embodiments of the present invention.

For example, depending on circumstances, the corrugated tube may have a corrugated portion in shape of corrugations that are not continued but independent with one another in an axial direction, namely annular corrugations, or a corrugated portion in shape of corrugation that is continued spirally. Or the present invention may be applied for a hose including a corrugated tube made of resin or other material or for a hose having only a single layer of a corrugated tube. The present invention may be constructed and embodied in various configurations and modes within the scope of the present invention.

We claim:

1. A hose with a corrugated tube, comprising:
a corrugated tube disposed as an innermost layer, the corrugated tube having a corrugated portion in a shape of corrugations continued in an axial direction,
each of the corrugations including a corrugation hill on a radially outer side thereof and a corrugation valley on a radially inner side thereof, the corrugated portion having an inside space or inside spaces inside the corrugated portion, the inside space or the inside spaces communicating with an inner space within the corrugated tube where fluid flows, and
the corrugated portion having a restraining structure for restraining generation of turbulent flow in a fluid flow in the inner space or generation of vibrating noise due to the fluid flow in the inner space.

2. The hose with a corrugated tube as set forth in claim 1, wherein the restraining structure is constructed such that the corrugation includes the corrugation valley having a bottom portion shaped flat and straight in an axial direction so as to define an axially straight cylindrical inner surface, and
an axial length B of an opening portion defined between adjacent said corrugation valleys and an axial length A of the corrugation valley has a relationship of 0.15A=or<B=or<0.5A.

3. The hose with a corrugated tube as set forth in claim 2, wherein the axial length B of the opening portion is smaller than an axial length C of a space inside the corrugation hill of the corrugation, and thereby the space inside the corrugation hill is wider than the opening portion.

4. The hose with a corrugated tube as set forth in claim 3, wherein a portion, which extends from the bottom portion of one said corrugation valley to the bottom portion of the corrugation valley adjacent to the one corrugation valley via a top portion of the corrugation hill between the one and adjacent corrugation valleys, has a sectional shape like a letter Ω.

5. The hose with a corrugated tube as set forth in claim 1, wherein an axial distance D between adjacent said corrugation hills and an axial length E of the corrugation hill has a relationship of 0.16E=or<D.

6. The hose with a corrugated tube as set forth in claim 1, wherein the restraining structure is constructed such that the corrugation is formed so as to be inclined in an axial direction of the corrugated tube and in an opposite direction of conveying a fluid.

7. The hose with a corrugated tube as set forth in claim 6, wherein the corrugation is formed so as to be inclined at an angle θ equal to or higher than 30° and lower than 90°.

8. The hose with a corrugated tube as set forth in claim 6, wherein the corrugation includes the corrugation valley having a bottom portion shaped flat and straight in an axial direction so as to define an axially straight cylindrical inner surface.

9. The hose with a corrugated tube as set forth in claim 6, wherein a portion, which extends from a bottom portion of one said corrugation valley to a bottom portion of the corrugation valley adjacent to the one corrugation valley via a top portion of the corrugation hill between the one and adjacent corrugation valleys, has a sectional shape of a right triangle having a hypotenuse that is inclined inwardly from the top portion of the corrugation hill toward a direction of conveying a fluid.

10. The hose with a corrugated tube as set forth in claim 1, wherein the restraining structure is constructed such that a stepped configuration is provided between bottom portions of adjacent said corrugation valleys, a starting end X₂ of the bottom portion of the corrugation valley on a downstream side of fluid conveyance is located radially outward relative to a terminal end X₁ of the bottom portion of the corrugation valley on an upstream side thereof, and each of the bottom portions is sloped so as to approach close to an axis of the corrugated tube from the upstream side toward the downstream side.
